(19) United States
(12) Patent Application Publication
(10) Pub. No.: US 2025/0193068 A1
(43) Pub. Date: Jun. 12, 2025

(54) FAULT MANAGEMENT IN A COMMUNICATION SYSTEM

(71) Applicant: Afiniti AI Limited, Dublin (IE)

(72) Inventors: Qiaobing XIE, Chesterfield, MO (US); Hassan AFZAL, Bethesda, MD (US)

(73) Assignee: Afiniti AI Limited, Dublin (IE)

(21) Appl. No.: 18/982,651

(22) Filed: Dec. 16, 2024

Related U.S. Application Data
(63) Continuation of application No. PCT/US2023/025866, filed on Jun. 21, 2023.
(60) Provisional application No. 63/354,556, filed on Jun. 22, 2022.

(51) Int. Cl. H04L 41/0663; H04M 3/51

(52) U.S. Cl. CPC H04L 41/0663; H04M 3/51

(57) ABSTRACT

A method for fault recovery in a communication system comprising an active node and a first standby node. The method includes the active node performing an action, wherein an information block is generated as a result of performing the action. The method also includes the active node transmitting to the first standby node an information update message comprising the information block or an action identifier identifying the action. The method further includes the first standby node sending to a second standby node an information update message comprising the information block or the action identifier.

### CROSS-REFERENCE TO RELATED APPLICATIONS

This application is a continuation of International Patent Application No. PCT/US2023/025866, filed on 2023 Jun. 21, which claims priority to U.S. Provisional Patent Application No. 63/354,556, filed on 2022 Jun. 22. The above identified applications are incorporated by this reference.

### TECHNICAL FIELD

Disclosed are embodiments related to fault management in a communication system.

### BACKGROUND

An example of a communication system is a contact center system (a.k.a., call center system). A contact center system may employ a pairing module that functions to assign contacts (a.k.a., calls) to agents available to handle those contacts. At times, the contact center may have agents available and waiting for assignment to inbound or outbound contacts (e.g., telephone calls, Internet chat sessions, email). At other times, the contact center may have contacts waiting in one or more queues for an agent to become available for assignment.

### SUMMARY

Certain challenges presently exist. For instance, it is advantageous for a communication system, such as, for example, a contact center system, to achieve high availability. That is, it is important that the system be able to provide continuous, uninterrupted services after suffering component or network failures. Typical high-availability models, such as a typical active-standby redundant deployment model, where an active node is responsible in delivering communication services while the standby node is ready to take over the serving responsibility in case the active node fails, cannot achieve high-availability for active contacts and agents in a contact center system. For a higher degree of service survivability, it is also desirable to have more than one standby node in the system so that the service can continue even after multiple consecutive failures.

Accordingly, in one aspect there is provided a method for fault recovery in a communication system comprising an active node and a first standby node.

In one embodiment, the method includes: the active node performing an action, wherein an information block is generated as a result of performing the action; the active node transmitting to the first standby node an information update message comprising the information block or an action identifier identifying the action; and the first standby node sending to a second standby node an information update message comprising the information block or the action identifier.

In another embodiment, the method includes: the active node performing an action, whereby an information block is generated as a result of performing the action and the active node transmitting to the first standby node an information update message comprising an action identifier identifying the action.

In another aspect there is provided a computer program comprising instructions which when executed by processing circuitry of an apparatus causes the apparatus to perform any of the methods disclosed herein. In one embodiment, there is provided a carrier containing the computer program wherein the carrier is one of an electronic signal, an optical signal, a radio signal, and a computer readable storage medium. In another aspect there is provided an apparatus that is configured to perform the methods disclosed herein. The apparatus may include memory and processing circuitry coupled to the memory.

### BRIEF DESCRIPTION OF THE DRAWINGS

The accompanying drawings, which are incorporated herein and form part of the specification, illustrate various embodiments.

FIG. 1A illustrates an example communication system according to an embodiment.

FIG. 1B illustrates an example communication system according to an embodiment.

FIG. 1C illustrates an example communication system according to an embodiment.

FIG. 1D illustrates an example communication system according to an embodiment.

FIG. 2 illustrates an example daisy-chain node configuration.

FIG. 3 is a flowchart illustrating a process according to an embodiment.

FIG. 4A is a flowchart illustrating a process according to an embodiment.

FIG. 4B is a flowchart illustrating a process according to an embodiment.

FIG. 5 is a block diagram of a node according to an embodiment.

FIG. 6A is a flowchart illustrating a process according to an embodiment.

FIG. 6B is a flowchart illustrating a process according to an embodiment.

### DETAILED DESCRIPTION

As used herein, the term “module” may be understood to refer to software, firmware, hardware, and/or various combinations thereof. Modules, however, are not to be interpreted as software which is not implemented on hardware, firmware, or recorded on a computer readable recordable storage medium (i.e., modules are not software per se). It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in both devices.

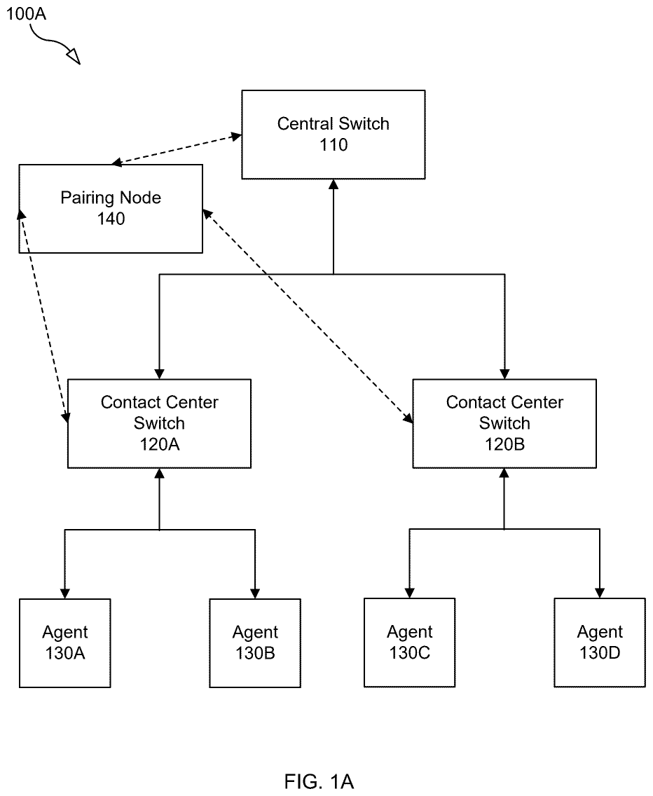

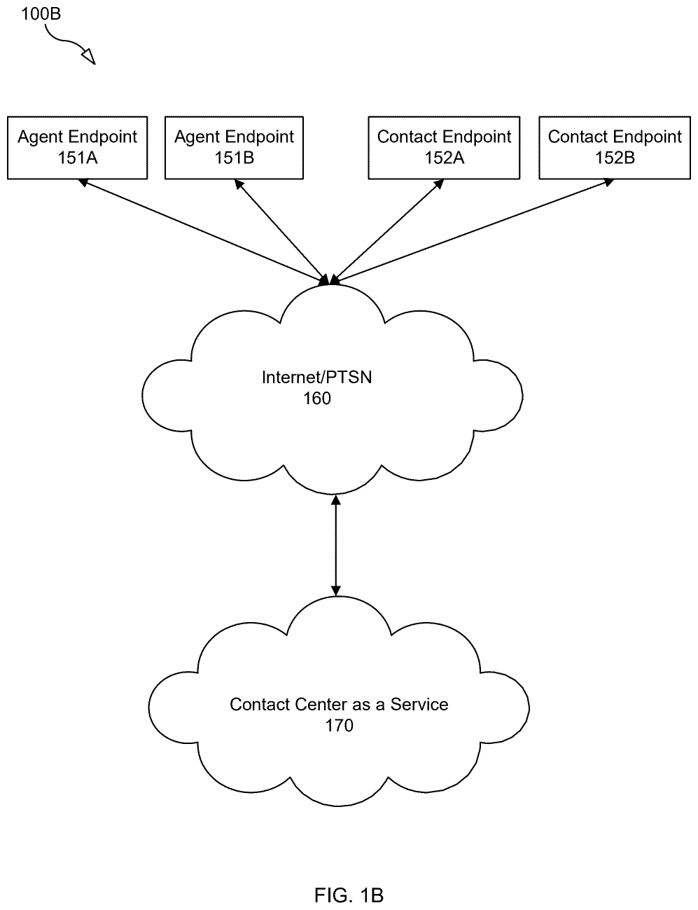

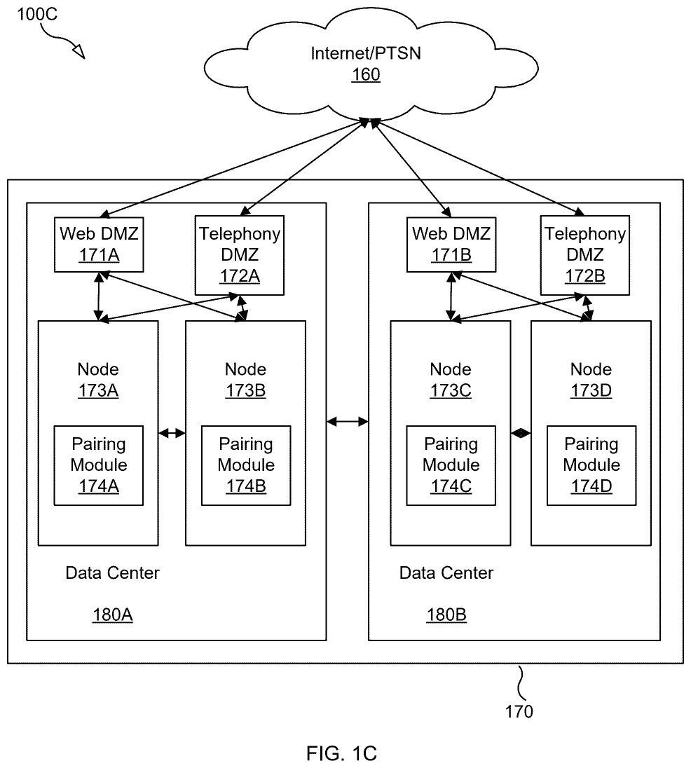

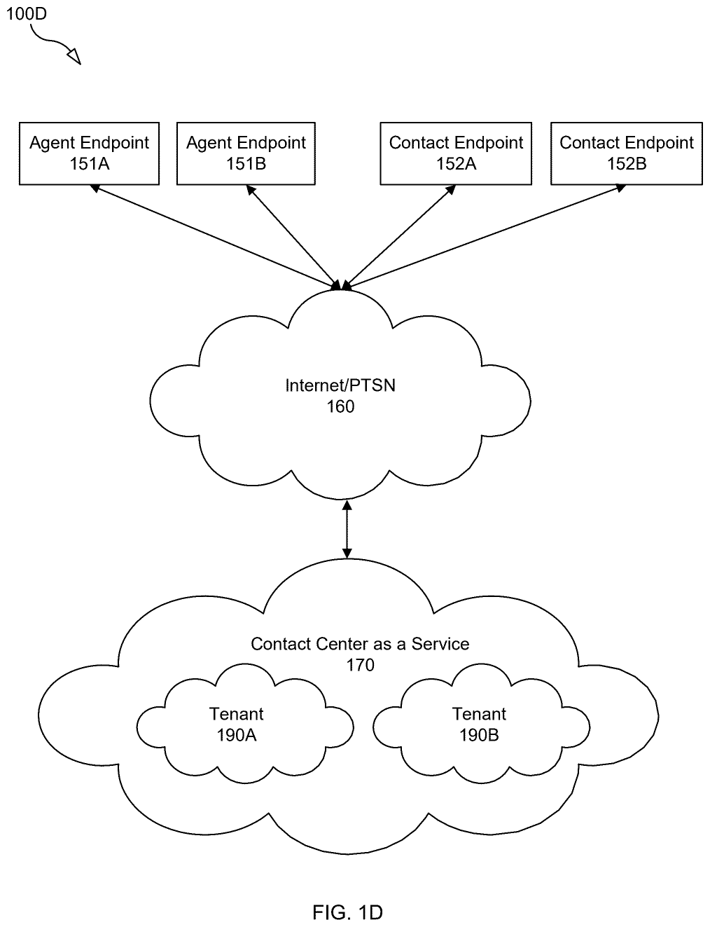

FIG. 1A illustrates an example communication system 100A. In this example, communication system 100A is a contact center system. As shown in FIG. 1A, the communication system 100A may include a central switch 110. The central switch 110 may receive incoming contacts (e.g., telephone callers) or support outbound connections to contacts via a telecommunications network (not shown). The central switch 110 may include contact routing hardware and software for helping to route contacts among one or more contact centers, or to one or more Private Branch Exchanges (PBXs) and/or Automatic Call Distributers (ACDs) or other queuing or switching components, including other Internet-based, cloud-based, or otherwise networked contact-agent hardware or software-based contact center solutions.

The central switch 110 may not be necessary such as if there is only one contact center, or if there is only one PBX/ACD routing component, in the communication system 100A. If more than one contact center is part of the communication system 100A, each contact center may include at least one contact center switch (e.g., contact center switches 120A and 120B). The contact center switches 120A and 120B may be communicatively coupled to the central switch 110. In embodiments, various topologies of routing and network components may be configured to implement the contact center system.

Each contact center switch for each contact center may be communicatively coupled to a plurality (or “pool”) of agents. Each contact center switch may support a certain number of agents (or “seats”) to be logged in at one time. At any given time, a logged-in agent may be available and waiting to be connected to a contact, or the logged-in agent may be unavailable for any of a number of reasons, such as being connected to another contact, performing certain post-call functions such as logging information about the call, or taking a break.

In the example of FIG. 1A, the central switch 110 routes contacts to one of two contact centers via contact center switch 120A and contact center switch 120B, respectively. Each of the contact center switches 120A and 120B are shown with two agents each. Agents 130A and 130B may be logged into contact center switch 120A, and agents 130C and 130D may be logged into contact center switch 120B.

The communication system 100A may also be communicatively coupled to an integrated service from, for example, a third-party vendor. In the example of FIG. 1, a pairing module 140 may be communicatively coupled to one or more switches in the switch system of the communication system 100, such as central switch 110, contact center switch 120A, or contact center switch 120B. In some embodiments, switches of the communication system 100A may be communicatively coupled to multiple pairing modules. In some embodiments, pairing module 140 may be embedded within a component of a contact center system (e.g., embedded in or otherwise integrated with a switch). The pairing module 140 may receive information from a switch (e.g., contact center switch 120A) about agents logged into the switch (e.g., agents 130A and 130B) and about incoming contacts via another switch (e.g., central switch 110) or, in some embodiments, from a network (e.g., the Internet or a telecommunications network) (not shown).

A contact center may include multiple pairing modules. In some embodiments, one or more pairing modules may be components of pairing module 140 or one or more switches such as central switch 110 or contact center switches 120A and 120B. In some embodiments, a pairing module may determine which pairing module may handle pairing for a particular contact. For example, the pairing module may alternate between enabling pairing via a Behavioral Pairing (BP) module and enabling pairing with a First-in-First-out (FIFO) module. In other embodiments, one pairing module (e.g., the BP module) may be configured to emulate other pairing strategies.

FIG. 1B illustrates a second example communication system 100B. As shown in FIG. 1B, the communication system 100B may include one or more agent endpoints 151A, 151B and one or more contact endpoints 152A, 152B. The agent endpoints 151A, 151B may include an agent terminal and/or an agent computing device (e.g., laptop, cellphone). The contact endpoints 151A, 151B may include a contact terminal and/or a contact computing device (e.g., laptop, cellphone). Agent endpoints 151A, 151B and/or contact endpoints 152A, 152B may connect to a Contact Center as a Service (CCaaS) 170 through either the Internet or a public switched telephone network (PSTN), according to the capabilities of the endpoint device.

FIG. 1C illustrates an example communication system 100C with an example configuration of a CCaaS 170. For example, a CCaaS 170 may include multiple data centers 180A, 180B. The data centers 180A, 180B may be separated physically, even in different countries and/or continents. The data centers 180A, 180B may communicate with each other. For example, one data center is a backup for the other data center; so that, in some embodiments, only one data center 180A or 180B receives agent endpoints 151A, 151B and contact endpoints 152A, 152B at a time.

Each data center 180A, 180B includes web demilitarized zone equipment 171A and 171B, respectively, which is configured to receive the agent endpoints 151A, 151B and contact endpoints 152A, 152B, which are communicatively connecting to CCaaS via the Internet. Web demilitarized zone (DMZ) equipment 171A and 171B may operate outside a firewall to connect with the agent endpoints 151A, 151B and contact endpoints 152A, 152B while the rest of the components of data centers 180A, 180B may be within said firewall (besides the telephony DMZ equipment 172A, 172B, which may also be outside said firewall). Similarly, each data center 180A, 180B includes telephony DMZ equipment 172A and 172B, respectively, which is configured to receive agent endpoints 151A, 151B and contact endpoints 152A, 152B, which are communicatively connecting to CCaaS via the PSTN. Telephony DMZ equipment 172A and 172B may operate outside a firewall to connect with the agent endpoints 151A, 151B and contact endpoints 152A, 152B while the rest of the components of data centers 180A, 180B (excluding web DMZ equipment 171A, 171B) may be within said firewall.

Further, each data center 180A, 180B may include one or more nodes 173A, 173B, and 173C, 173D, respectively. All nodes 173A, 173B and 173C, 173D may communicate with web DMZ equipment 171A and 171B, respectively, and with telephony DMZ equipment 172A and 172B, respectively. In some embodiments, only one node in each data center 180A, 180B may be communicating with web DMZ equipment 171A, 171B and with telephony DMZ equipment 172A, 172B at a time.

Each node 173A, 173B, 173C, 173D may have one or more pairing modules 174A, 174B, 174C, 174D, respectively. Similar to pairing module 140 of communications system 100A of FIG. 1A, pairing modules 174A, 174B, 174C, 174D may pair contacts to agents. For example, the pairing module may alternate between enabling pairing via a Behavioral Pairing (BP) module and enabling pairing with a First-in-First-out (FIFO) module. In other embodiments, one pairing module (e.g., the BP module) may be configured to emulate other pairing strategies.

Turning now to FIG. 1D, the disclosed CCaaS communication systems (e.g., FIGS. 1B and/or 1C) may support multi-tenancy such that multiple contact centers (or contact center operations or businesses) may be operated on a shared environment. That is, multiple tenants, each with their own set of non-overlapping agents, may be handled by the disclosed CCaaS communication systems, where each agent is only interacting with the contacts of a single tenant. CCaaS 170 is shown in FIG. 1D as comprising two tenants 190A and 190B. Turning back to FIG. 1C, for example, multi-tenancy may be supported by node 173A supporting tenant 190A while node 173B supports 190B. In another embodiment, data center 180A supports tenant 190A while data center 180B supports tenant 190B. In another example, multi-tenancy may be supported through a shared machine or shared virtual machine; such at node 173A may support both tenants 190A and 190B, and similarly for nodes 173B, 173C, and 173D.

In other embodiments, the system may be configured for a single tenant within a dedicated environment such as a private machine or private virtual machine.

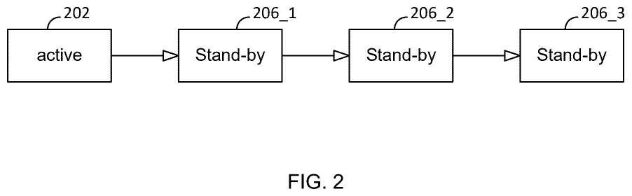

As noted above, it is advantageous for a communication system, such as, for example, communication systems 100A, 100B, 100C, 100D, to achieve high availability. Accordingly, in the embodiments disclosed herein, an active-standby redundant deployment model is employed. For example, FIG. 2 illustrates a logical configuration of an active node 202 (e.g., a node comprising a pairing module 140) and 3 backup (or “standby”) nodes 206_1, 206_2, and 206_3. Such a logical configuration is exemplary as the communication system can have any number of standby nodes. Active node 202 is responsible for delivering communication services (e.g., pairing a contact with an agent) while each standby node is ready to take over the serving responsibility in case all nodes logically configured before said standby node fail.

In order for a standby node (e.g., node 206_1) to successfully and quickly take over the serving responsibility, the standby node needs to maintain a copy of certain service information stored in the active node, such as, for example contact attributes, agent attributes, etc. This service information is usually highly dynamic (i.e., changes frequently) and of large volume, particularly in a large-scale communication system. Therefore, the present disclosure newly provides a data synchronization mechanism from the active node to the standby node(s) to implement such a high availability communication system.

By comparison to the presently-disclosed systems and techniques, a conventional active-standby node combination typically performs the following steps: 1) when the active node performs an action, the active node stores in its service information storage (e.g., a database) an information block resulting from the action; 2) the active node sends a copy of the information block to a standby node; and 3) when the standby receives the information block, it updates its local copy of the service information accordingly. Information block data transfers occur on the magnitude of seconds, or tens of seconds or minutes if the information block data transfer is large enough, and so, information block transfers are always a time-consuming process.

If such a conventional active-standby node combination were used for a contact center, all calls—including (1) calls where agents are connected to contacts, and (2) calls that are on hold in a queue—would be disconnected when the active node goes offline, even if there were a standby node, because the backup of information is too slow to be designed to manage transitional or active call state, especially for contact centers that handle hundreds or thousands of events per minute.

Additionally, when multiple standby nodes are configured in a system, such active-standby node combination is typically implemented using a star topology, where the active node “pushes” out the service information updates to all the standby nodes configured in the system. Such a configuration, however, has drawbacks, including increasing the load of the active node because (1) the active node is responsible for “pushing” out the service information updates to every standby node, and (2) any updates in the topology, such as an addition or subtraction of a node from the topology, require a software change to the active node to account for sending more or fewer “pushes” according to the updated number of standby nodes. Particularly, regarding (2), changes in the active-standby node topology, or, in fact, any updates to the active node software, are typically made when the active node is offline. Systems and methods do not exist to provide for updates to the active node while the active node itself is in use due to low fault tolerance of conventional systems.

This disclosure describes, among other things, two solutions to these problems, which can be used together or separately in a contact center system.

The first solution is a “daisy-chain” communication topology to more efficiently synchronize active node service information from a first, active node in the contact center system to multiple standby nodes in the contact center system. This daisy-chain topology is illustrated in FIG. 2. For example, node 202 of FIG. 2 corresponds to node 173A of FIG. 1C, and nodes 206-1, 206-2, 206-3 of FIG. 2 correspond to nodes 173B, 173C, 173D of FIG. 1C.

As shown in FIG. 2, the active node of a contact center system will form the head of a daisy-chain 200 and will only send information update messages to the standby node that is logically “directly” connected to the active node (i.e., standby node 206_1 in this example). Every time standby node 206_1 receives from the active node an information update message (e.g., updated service information or action identifier that enables node 206_1 to generate the updated service information, as described below), node 206_1 will update its own local copy of the service information and also forward (relay) the information update to standby node 206_2, which is the “next” standby node in the daisy chain after standby node 206_1. Similarly standby node 206_2 will perform the same local-update-then-forward operation so that the same service information update will be propagated down the daisy-chain until it reaches the end of the daisy-chain (standby node 206_3 in this example).

An advantage of this daisy-chain topology is that the active node only needs to send an information update message to one standby node regardless how many standby nodes have been configured in the system. Comparing to a typical “star” topology, this daisy-chain topology greatly reduces the resources consumption (in terms of both CPU cycles and network bandwidth) on the active node for “pushing” out the service information updates.

Another advantage is that the daisy-chain topology makes re-configuration (e.g., scale up or scale down) of the high availability system extremely efficient during operation. For example, assuming that a user decides to scale-up its high availability capability by adding a new standby node during operation, with the daisy-chain topology, the user can simply add the new standby node to the end of the daisy-chain topology or insert the new standby node in the middle of the daisy-chain topology without requiring a heavy-bandwidth change from the active node to newly sync with another standby node. Similarly, individual active or standby nodes can be taken offline temporarily for maintenance and reinserted into the system without any downtime in the contact center system. In conventional star topologies, the active node will restart, or require a software update, when reconfiguring the topology; if used in a contact center, the contact center would need to be offline. A daisy chain topology allows reconfiguration of the topology to occur while a contact center is online.

The second solution uses “action synchronization” to replace the traditional data replication approach. With action synchronization, instead of the active node sending to a standby node an information update message comprising an information block that was generated based on the active node performing an action (i.e., a process that includes one more steps), the active node sends an information update message comprising an action identifier identifying the action. Upon receiving the information update message, the standby node performs the identified action, resulting in the exact same changes to its local copy of the service information (i.e., information block), thus achieving the same effect as the traditional data replication. For example, actions at a contact center system that are performed by the active node may include instructions:
to create a new agent object and fill the new agent object with relevant agent details;
to modify part of an existing agent object;
to create a new contact object and fill the new contact object with relevant agent details;
to modify part of an existing contact object;
to create state information for a new contact;
to create state information for a new agent;
to modify state information for an existing contact; and/or
to modify state information for an existing agent.

In some embodiments, before the action synchronization approach can be used, the standby node needs to be synchronized with the active node so that the standby node has the same service information as the active node (e.g., a “brain dump”). Once the standby node is synchronized with the active node, the active node can begin using the application replication approach. Accordingly, as an example, assume that the active node has created 1000 agent objects and 50 call objects. In this scenario, the active node may first provide to the standby node instructions to create all 1000 agent objects and all 50 call objects with all the same parameters as currently existing on the active node, so that the standby node will be synchronized with the active node. After this “brain dump” is completed, if the active node performs an action using a particular set of parameters and the performance of this action results in a new call object, the active node can replicate its data to the standby node by merely sending to the standby node the action identifier and the set of parameters, which will then trigger the standby node to perform the identified action using the set of parameters, which will result in the standby node creating a new call object identical to the call object created by the active node. In this way, the standby node can stay synchronized with the active node.

An advantage of the action synchronization approach is that it uses less resources than the traditional approach because less data is sent out from the active node. The information update message, which identifies the action, is much smaller than the data changes (information block) resulting from the action. For example, an information update message that identifies the action “create new call” can be conveyed with a relatively small message (e.g., 12 bytes), while the new call object resulting from this action can have a relatively much larger size (e.g., several kilobytes (KB)). As a result, for the same system scale and load level, the amount of synchronization traffic the active node needs to send to a standby node can potentially be reduced significantly using action synchronization. This reduction in traffic can help the system scalability greatly since it saves both CPU cycles and network bandwidth on the active node.

Another advantage is that, in comparison to conventional active-standby systems that use information block data transfers (and which take seconds, or tens of seconds, for the standby node to receive updates from the active node), the information update message, which identifies the action, can be transmitted from the active node to the standby node much faster (e.g., on the magnitude of nanoseconds or microseconds). Further, the action synchronization approach is also faster because the information update message can be transmitted from the active node to the passive node while the active node itself is still processing the information update message. Therefore, this is unlike in a conventional system, where the standby node must first wait for the active node to process the action, create the new information state, and send the new information state to the standby node. In this way, the standby node can receive and even begin processing the action and updating its own memory/state information before the active node completes. This is additionally beneficial if the health of the active node begins to degrade; the standby node may have an accurate memory/state information even if the memory of the active node has a failure when performing the action.

Another advantage is that the action synchronization approach reduces the chance of data corruption on the standby node due to network problems over the sync traffic such as reconnections and data losses. In order to prevent data corruption (e.g., partial data update), traditional data replication usually needs to employ complicated data integrity protection such as cyclic-redundancy-check (CRC), Forward Error Correction (FEC) coding to help detect and recovery from sync traffic data loss. With action synchronization, this becomes much less an issue because the action identifiers sent from the active node may have built-in semantics and their data integrity can be easily verified by the standby node, without needing any additional data integrity protection. If an incomplete or compromised action identifier is received, the standby node will automatically find the action identifier inapplicable and will discard it. This may result in a small out-of-sync situation for the involved object, but will not cause data corruption on the standby node. The system is highly fault tolerant, so if a standby node has slightly outdated state information for a contact object or agent object, the object is still easily recoverable by the standby node, if needed. Therefore, the present disclosure does not require a “brain dump” each time there is an imperfect action ID.

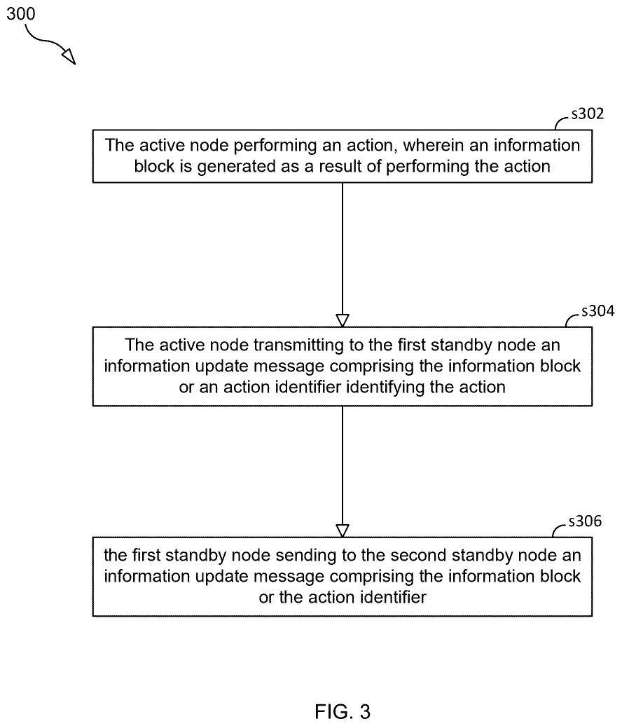

FIG. 3 is a flow chart illustrating a process 300, according to an embodiment. Process 300 may begin in step s302. Step s302 comprises an active node of a communication system performing an action, wherein an information block is generated as a result of performing the action. Step s304 comprises the active node transmitting to a first standby node of the communication system an information update message comprising the information block or an action identifier identifying the action. Step s306 comprise the first standby node sending to a second standby node of the communication system an information update message comprising the information block or the action identifier.

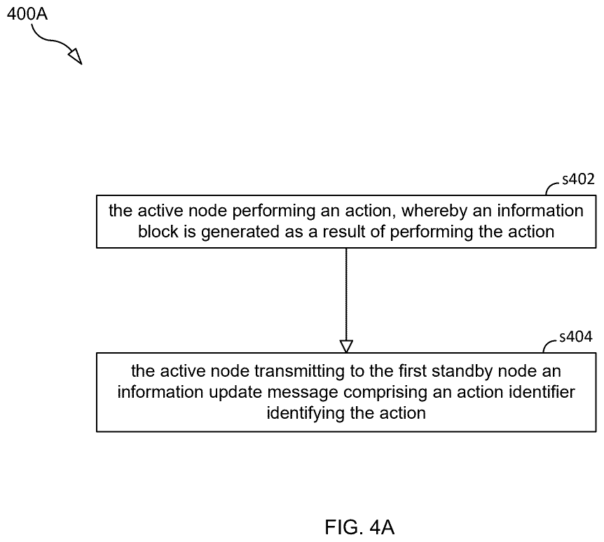

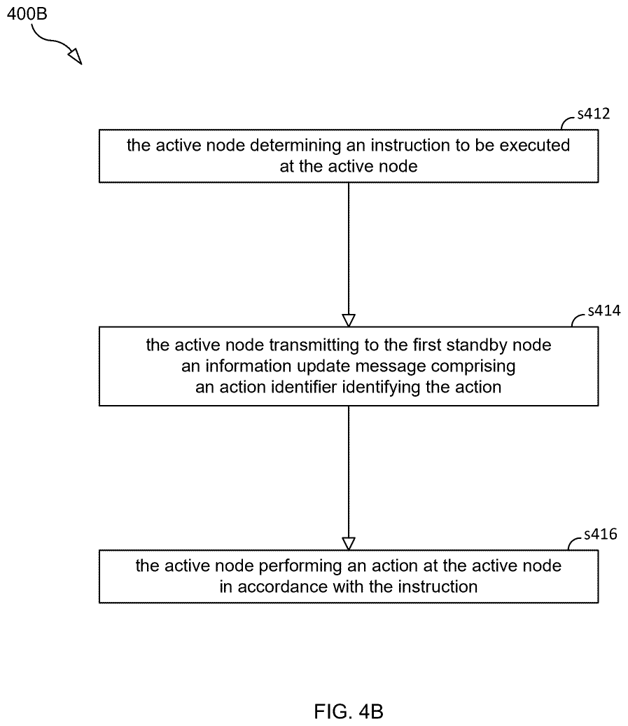

FIG. 4A is a flow chart illustrating a process 400A, according to an embodiment. Process 400 may begin in step s402. Step s402 comprises an active node of a communication system performing an action, whereby an information block is generated as a result of performing the action. Step s404 comprises the active node transmitting to the first standby node an information update message comprising an action identifier identifying the action.

FIG. 4B is a flow chart illustrating a process 400B, according to an embodiment. Process 400 may begin in step s412. Step s412 comprises an active node of a communication system determining an action instruction to be executed at the node. Step s414 comprises the active node transmitting to the first standby node an information update message comprising an action identifier identifying the action instruction. In some examples, the information update message may include any parameters needed to perform the action instruction. Step s416 comprises the active node performing an action according to the determined action instruction. For example, an information block may be generated as a result of performing the action. Although steps s414 and s416 are shown sequentially in FIG. 4B, steps s414 and s416 may be performed in any order, and/or may be performed simultaneously.

In the event of a failure of the active node in either of the processes 300, 400A, 400B, the first standby nodes take over the duties of the active node, thereby becoming an active node.

Therefore, the present disclosure provides a contact center system, with a plurality of nodes, where the nodes are communicatively coupled to each other in a daisy chain topology, and where synchronization between the nodes occurs through the disclosed action synchronization approach. For example, turning to FIG. 1C, node 173A may be an active node, and nodes 173B, 173C, 173D may be back-up nodes, such that node 173A syncs node 173B, node 173B syncs node 173C, and node 173C syncs node 173D according to the systems and methods disclosed herein.

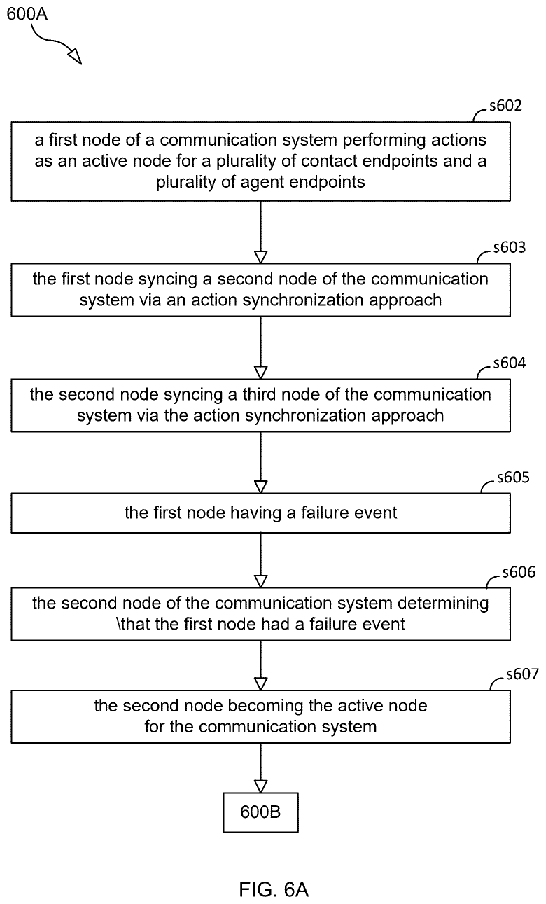

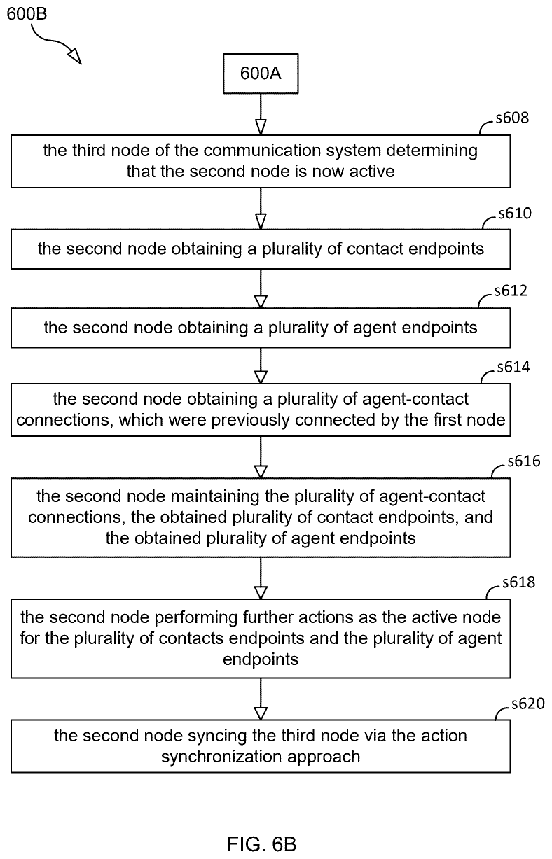

The disclosed contact center system is newly able to maintain the majority of contact connections to the CCaaS 170 even in the event of an active node failure. Prior contact center systems dropped all agent endpoints and contact endpoints in the event of an active node failure. Because of the disclosed action synchronization approach and in the disclosed daisy-chain topology, the backup node (e.g., node 173B) has nearly complete, within microseconds of accuracy, data that allows the backup node 173B to maintain the connections through the web DMZ 171a and telephony DMZ 172A in the event of an active node 172A failure. That is, even transitional calls—contact endpoints which are being transitioned from “on hold” in a queue of the contact center to a connection with an agent endpoint—might be maintained such that the agent endpoint is connected to a contact endpoint via the new active node 173B, as originally intended by the former active node 173A; this maintenance of transitional calls is due to the backup node 173B having data that is accurate to the time scale of recent microseconds. This process is demonstrated in FIG. 6.

FIGS. 6A-6B show a flow chart illustrating processes 600A and 600B, according to an embodiment. For example, process 600A occurs after processes 300, 400A, and/or 400B. Process 600A may begin in step s602. Step s602 comprises a first node of a communication system performing actions as an active node for a plurality of contact endpoints and a plurality of agent endpoints. Step s603 comprises the first node syncing a second node of the communication system via an action synchronization approach. For example, the action synchronization approach is as disclosed herein. Step s604 comprises the second node syncing a third node of the communication system via the action synchronization approach. Step s605 comprises the first node having a failure event. Step s606 comprises the second node of the communication system determining that the first node had a failure event. Step s607 comprises the second node becoming the active node for the communication system. After step s607, process 600A may proceed to process 600B of FIG. 6B.

Process 600B begins in step s608. Step s608 comprises the third node of the communications system determining that the second node is now active. Step s610 comprises the second node obtaining a plurality of contact endpoints (e.g., this may be contacts on hold in the contact center); for example, the second node obtains the plurality of contact endpoints from a memory of the second node. Step s612 comprises the second node obtaining a plurality of agent endpoints (e.g., this may be available agents at the contact center); for example, the second node obtains the plurality of agent endpoints from the memory of the second node. Step s614 comprises the second node obtaining a plurality of agent-contact connections, which were previously connected by the first node; for example, the second node obtains the plurality of contact-agent endpoints from the memory of the second node. Step s616 comprises the second node maintaining the plurality of agent-contact connections, maintaining the obtained plurality of contact endpoints, and maintaining the obtained plurality of agent endpoints. Step s618 comprises the second node performing further actions as the active node for the plurality of contact endpoints and the plurality of agent endpoints. Step s620 comprises the second node syncing the third node via the action synchronization approach.

For example, the first node is node 172A of FIG. 1C; the second node is node 172B of FIG. 1C, the third node is node 172C of FIG. 1C. For example, in addition to the first node, there may be 2, 3, 4, 5, 10, 15, 20, etc. standby nodes.

Therefore, even if an entire data center had a failure event (e.g., data center 180A) which incapacitated both the active node 172A and the first standby node 172B, the third node 172C at a second data center 180B would be able to become the active node for the CCaaS, and proceed as contemplated herein.

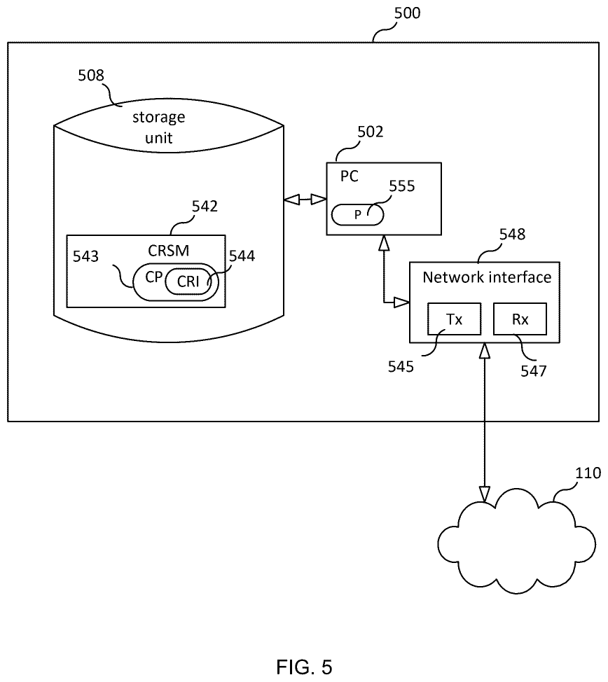

FIG. 5 is a block diagram of a node 500, according to some embodiments. Node 500 can be an active node or a standby node. As shown in FIG. 5, node 500 may comprise: processing circuitry (PC) 502, which may include one or more processors (P) 555 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., node 500 may be a distributed computing apparatus); at least one network interface 548 (e.g., a physical interface or air interface) comprising a transmitter (Tx) 545 and a receiver (Rx) 547 for enabling node 500 to transmit data to and receive data from other nodes connected to a network 110 (e.g., an Internet Protocol (IP) network) to which network interface 548 is connected (physically or wirelessly) (e.g., network interface 548 may be coupled to an antenna arrangement comprising one or more antennas for enabling node 500 to wirelessly transmit/receive data); and a storage unit (a.k.a., “data storage system”) 508, which may include one or more non-volatile storage devices and/or one or more volatile storage devices. In embodiments where PC 502 includes a programmable processor, a computer readable storage medium (CRSM) 542 may be provided. CRSM 542 may store a computer program (CP) 543 comprising computer readable instructions (CRI) 544. CRSM 542 may be a non-transitory computer readable medium, such as, magnetic media (e.g., a hard disk), optical media, memory devices (e.g., random access memory, flash memory), and the like. In some embodiments, the CRI 544 of computer program 543 is configured such that when executed by PC 502, the CRI causes node 500 to perform steps described herein (e.g., steps described herein with reference to the flow charts). In other embodiments, node 500 may be configured to perform steps described herein without the need for code. That is, for example, PC 502 may consist merely of one or more ASICs. Hence, the features of the embodiments described herein may be implemented in hardware and/or software.

### Summary of Various Embodiments

A1. A method 300 (see FIG. 3) for fault recovery in a communication system comprising an active node, a first standby node and a second standby node, the method comprising: the active node performing an action, wherein an information block is generated (e.g., a new information block is created or an existing information block is updated) as a result of performing the action; the active node transmitting to the first standby node an information update message comprising the information block or an action identifier identifying the action; and the first standby node sending to the second standby node an information update message comprising the information block or the action identifier.
A2. The method of embodiment A1, wherein the information update message comprises the action identifier identifying the action.
A3. The method of embodiment A2, further comprising: in response to receiving the information update message transmitted by the active node, the first standby node generating the information block by performing the action identified by the action identifier.
A4. The method of any one of embodiments A1-A3, further comprising: prior to the active node transmitting to the first standby node the information update message, the active node determining that the first standby node is the first node in an ordered set of standby nodes, wherein the active node transmits the information update message to the first standby node as a result of having determined that the first standby node is the first node in the ordered set of nodes.
A5. The method of any one of embodiments A1-A4, wherein the active node is an active pairing module in a contact center system, and the first standby node is a standby pairing module in the contact center system.
A6. The method of any one of embodiments A1-A5, further comprising, prior to the active node performing the action, synchronizing the standby node with the active node.
A7. The method of embodiment A6, wherein synchronizing the standby node with the active node comprises the active node transmitting to the standby node a plurality of data objects.
B1. A method 400 (see FIG. 4) for fault recovery in a communication system comprising an active node and a first standby node, the method comprising: the active node performing an action, whereby an information block is generated as a result of performing the action; and the active node transmitting to the first standby node an information update message comprising an action identifier identifying the action.
B2. The method of embodiment B1, further comprising: in response to receiving the information update message, the first standby node generating the information block by performing the action identified by the action identifier.
B3. The method of embodiment B2, further comprising after receiving the information update message, the first standby node transmitting to a second standby node a message comprising the action identifier or the information block.
B4. The method of any one of embodiments B1-B3, further comprising: prior to the active node transmitting to the first standby node the information update message, the active node determining that the first standby node is the first node in an ordered set of standby nodes, wherein the active node transmits the information update message to the first standby node as a result of having determined that the first standby node is the first node in the ordered set of nodes.
B5. The method of any one of embodiments B1-B4, wherein the active node is an active pairing module in a contact center system, and the first standby node is a standby pairing module in the contact center system.
B6. The method of any one of embodiments B1-B5, further comprising, prior to the active node performing the action, synchronizing the standby node with the active node.
B7. The method of embodiment B6, wherein synchronizing the standby node with the active node comprises the active node transmitting to the standby node a plurality of data objects.
C1. A computer program 543 comprising instructions 544 which when executed by processing circuitry 502 of a node causes the node to perform the method of any one of the above embodiments.
C2. A carrier containing the computer program of embodiment C1, wherein the carrier is one of an electronic signal, an optical signal, a radio signal, and a computer readable storage medium 542.
D1. A node 500, the node comprising processing circuitry and being configured to perform the method of any one of embodiments A1-A7 and B1-B7.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for fault recovery in a communication system comprising an active node, a first standby node, and a second standby node, the method comprising:
the active node performing an action, wherein an information block is generated as a result of performing the action;
the active node transmitting to the first standby node an information update message comprising the information block or an action identifier identifying the action; and
the first standby node sending to the second standby node an information update message comprising the information block or the action identifier.

2. The method of claim 1, wherein the information update message comprises the action identifier identifying the action.

3. The method of claim 2, further comprising:
in response to receiving the information update message transmitted by the active node, the first standby node generating the information block by performing the action identified by the action identifier.

4. The method of claim 1, further comprising:
prior to the active node transmitting to the first standby node the information update message, the active node determining that the first standby node is the first node in an ordered set of standby nodes, wherein
the active node transmits the information update message to the first standby node as a result of having determined that the first standby node is the first node in the ordered set of nodes.

5. The method of claim 1, wherein
the active node is an active pairing module in a contact center system, and
the first standby node is a standby pairing module in the contact center system.

6. The method of claim 1, further comprising, prior to the active node performing the action, synchronizing the standby node with the active node.

7. The method of claim 6, wherein synchronizing the standby node with the active node comprises the active node transmitting to the standby node a plurality of data objects.

8. A non-transitory computer readable storage medium storing a computer program comprising instructions for configuring a node comprising processing circuitry for executing the instructions to perform the method of claim 1.

9. A method for fault recovery in a communication system comprising an active node and a first standby node, the method comprising:
the active node performing an action, wherein an information block is generated as a result of performing the action; and
the active node transmitting to the first standby node an information update message comprising an action identifier identifying the action.

10. The method of claim 9, further comprising:
in response to receiving the information update message, the first standby node generating the information block by performing the action identified by the action identifier.

11. The method of claim 10, further comprising
after receiving the information update message, the first standby node transmitting to a second standby node a message comprising the action identifier or the information block.

12. The method of claim 9, further comprising:
prior to the active node transmitting to the first standby node the information update message, the active node determining that the first standby node is the first node in an ordered set of standby nodes, wherein
the active node transmits the information update message to the first standby node as a result of having determined that the first standby node is the first node in the ordered set of nodes.

13. The method of claim 9, wherein
the active node is an active pairing module in a contact center system, and
the first standby node is a standby pairing module in the contact center system.

14. The method of claim 9, further comprising, prior to the active node performing the action, synchronizing the standby node with the active node.

15. The method of claim 14, wherein synchronizing the standby node with the active node comprises the active node transmitting to the standby node a plurality of data objects.

16. A non-transitory computer readable storage medium storing a computer program comprising instructions for configuring a node comprising processing circuitry for executing the instructions to perform the method of claim 9.

17. An active node, the active node comprising:
processing circuitry; and
memory storing a computer program comprising instructions for configuring the active node to perform a method comprising:
performing an action, wherein an information block is generated as a result of performing the action;
transmitting to a first standby node an information update message comprising the information block or an action identifier identifying the action, wherein
the information update message transmitted to the first standby node triggers the first standby node to send to a second standby node an information update message comprising the information block or the action identifier.

18. The node of claim 17, wherein the method further comprises:
prior to the active node transmitting to the first standby node the information update message, the active node determining that the first standby node is the first node in an ordered set of standby nodes, wherein
the active node transmits the information update message to the first standby node as a result of having determined that the first standby node is the first node in the ordered set of nodes.

19. An active node, the active node comprising:
processing circuitry; and
memory storing a computer program comprising instructions for configuring the active node to perform a method comprising:
performing an action, wherein an information block is generated as a result of performing the action; and
transmitting to a first standby node an information update message comprising an action identifier identifying the action.

20. The node of claim 19, wherein the method further comprises
the first standby node generating the information block by performing the action identified by the action identifier in response to receiving the information update message.
